(19) United States
(12) Patent Application Publication
(10) Pub. No.: US 2022/0253882 A1
(43) Pub. Date: Aug. 11, 2022

(54) HYPERLINKS INCORPORATING PRODUCTS IN INTERNATIONAL-SCALE MULTI-LEVEL MARKETING SYSTEM

(71) Applicant: KwikClick, LLC, Murray, UT (US)

(72) Inventor: Fred Cooper, Farmington, UT (US)

(21) Appl. No.: 17/589,834

(22) Filed: Jan. 31, 2022

Related U.S. Application Data
(60) Provisional application No. 63/143,338, filed on Jan. 29, 2021.

(51) Int. Cl. G06Q 30/02

(52) U.S. Cl. CPC G06Q 30/0214

(57) ABSTRACT

Disclosed herein is a system and method to allow sellers of products to enroll individual products in an international multi-level marketing (MLM) system. A first individual that purchases a product may be enrolled as a distributor of the MLM system and this individual may be allowed to advertise the product to other individual who may then become a distributor of the product after they purchase the product. This second distributor may then advertise the product to yet other individuals who in turn may become a distributor of the product after they purchase the product. Each of these distributors may be assigned a code that is used to identify distributors that are owed commissions. Whenever a product is sold, commissions may be paid out to distributors using a currency associated with respective distributors. A chain of distributors located in the USA and Japan may be paid commissions in their local currency.

### CROSS-REFERENCE TO RELATED APPLICATION

The present application claims the priority benefit of U.S. provisional application No. 63/143,338 filed Jan. 29, 2021, the disclosure of which is incorporated herein by reference.

### BACKGROUND OF THE INVENTION

### Field of the Disclosure

The present disclosure is generally related to hyperlinking in multi-level marketing systems in different locations. More specifically, the present disclosure is directed to hyperlinks incorporating products in international-scale multi-level marketing systems.

### Description of the Related Art

A Multilevel marketing (MLM) system is a sales strategy used by some direct sales companies, which is used to encourage existing distributors to recruit new distributors who are paid a percentage of their recruits' sales. The recruits are the distributor's “downline.” Distributors also make money through direct sales of products to customers. Amway, which sells health, beauty, and home care products, is an example of a well-known direct sales company that uses multilevel marketing.

Multilevel marketing is a legitimate business sales strategy. One problem is that the MLM is organized as a pyramid tree. However, pyramid “schemes” that use money from new recruits to pay people at the top rather than those who perform the work is illegal. These pyramid schemes involve taking advantage of people by pretending to be engaged in legitimate multilevel or network marketing. You can spot pyramid schemes by their greater focus on recruitment than on product sales.

One issue in determining the legitimacy of a multilevel marketing company is whether it sells its products primarily to consumers or to its members who must recruit new members to buy their products. If it is the former, the company is likely a legitimate multilevel marketer. If it is the latter, it could be an illegal pyramid scheme.

Although each MLM company dictates its own specific financial compensation plan for the payout of any earnings to their respective participants, the common feature that is found across all MLMs is that the compensation plans theoretically pay out to participants only from two potential revenue streams. The first is paid out from commissions of sales made by the participants directly to their own retail customers. The second is paid out from commissions based upon the wholesale purchases made by other distributors below the participant who have recruited those other participants into the MLM; in the organizational hierarchy of MLMs, these participants are referred to as one's down line distributors.

MLM salespeople (distributors) are, therefore, expected to sell products directly to end-user retail consumers by means of relationship referrals and word of mouth marketing, but most importantly they are incentivized to recruit others to join the company's distribution chain as fellow salespeople so that these can become down line distributors.

Currently, in order to join an MLM, there is an initiation fee, which is a barrier against those that just wish to refer a single product they like. Current multi-level marketing (MLM) systems do not take full advantage of the internet and how consumers can influence other consumers to make purchases. Also, current MLM systems do not incorporate incentivizing users of a multi-level marketing system by offering a dynamic commission tree. In addition, there is no current MLM system that utilizes the money or funds dedicated to discounts or coupons to be reincorporated into a multi-level marketing system to incentive consumers to make purchases and advertise the product that they purchased. Further, because current MLM distribute their own products or those bought wholesale from a partnered manufacturer, there is no need to dynamically assess user geographic location and make changes to the existing commission structure based on changes in law from one jurisdiction to another. Even international MLMs like Amway slowly enter non-domestic markets after taking the time to set up distribution channels in those countries which are often contained within those countries and do not cross jurisdictional lines. What are needed are new methods that allow MLM organizations to operate internationally in a manner that conforms to the laws of countries where products are sold or commissions are earned.

### SUMMARY OF THE PRESENTLY CLAIMED INVENTION

The presently claimed invention is directed to a method and a non-transitory computer readable storage medium where a processor may execute instructions out of a memory to implement the method of the present disclosure. In a first embodiment, a method may include identifying a jurisdiction associated with a user of a user device based on data received from the user device, identifying that a product offering associated with a distributor can be provided to the user device via a language associated with the jurisdiction and with the data received from the user device, and initiating the sending of the product offering to the user device in the language associated with the jurisdiction and with the data received from the user device. This product offering may include a code associated with the distributor after. The user device may then be provided the product offering in the language. The present method may also include providing a commission for receipt by the distributor based on the user of the user device purchasing the product according to the product offering and the code.

In a second embodiment, a method of the present disclosure may be implemented as a non-transitory computer readable storage medium where a processor executes instructions out of a memory to implement the method of the present disclosure. Here again the method may include identifying a jurisdiction associated with a user of a user device based on data received from the user device, identifying that a product offering associated with a distributor can be provided to the user device via a language associated with the jurisdiction and with the data received from the user device, and initiating the sending of the product offering to the user device in the language associated with the jurisdiction and with the data received from the user device. This product offering may include a code associated with the distributor after. The user device may then be provided the product offering in the language. The present method may also include providing a commission for receipt by the distributor based on the user of the user device purchasing the product according to the product offering and the code.

### BRIEF DESCRIPTION OF THE DRAWINGS

FIG. 1 illustrates a system 100 for multi-level marketing of products via a set of computing devices.

FIG. 2 illustrates a method that may be performed by a computer such as the administration computer of FIG. 1.

FIG. 3 illustrates a series of steps that may be performed at a user device when product information is provided to a multi-level-management system.

FIG. 4 illustrates a method that may be performed by a computer such as the third party network computer of FIG. 1.

FIG. 5 illustrates steps that may be performed between an administration network computer and the third party network computer of FIG. 1.

FIG. 6 illustrates a computing system that may be used to implement an embodiment of the present invention.

### DETAILED DESCRIPTION

Disclosed herein is a system and method to allow sellers of products to enroll individual products in an international multi-level marketing (MLM) system that receives payments and distributes commissions using currencies associated with specific users or locations. A first individual that purchases a product may be enrolled as a distributor of the MLM system and this individual may be allowed to advertise the product to other individual who may then become a distributor of the product after they purchase the product. This second distributor may then advertise the product to yet other individuals who in turn may become a distributor of the product after they purchase the product. Each of these distributors may be assigned a code that is used to identify distributors that are owed commissions. Whenever a product is sold, commissions may be paid out to distributors using a currency associated with respective distributors. A chain of distributors located in the USA and Japan may be paid commissions in their local currency. This system may also account for changes in law, taxes, language, and/or currency, for example.

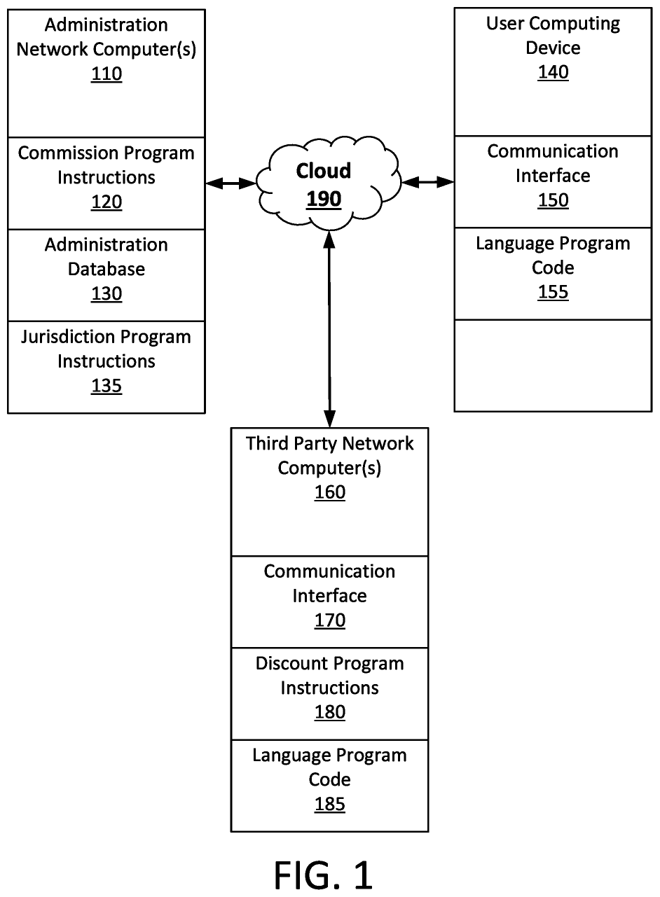

An administration network computer, as shown in FIG. 1, identifies that a product has been purchased from a user of the system (i.e. a first user). User data may be collected that identifies a preferred currency of the user or a geographic location where the user resides. This user data may also identify a location or country where the user is located, resides, makes a purchased from, or receives funds. Depending on circumstances, a user may be paid in a currency that the user selects or that is mandated by laws associated with where the user lives or is currently located. Once a user purchases a product, the system may generate an embedded coded link that connects (links) the referrer to the purchaser(s). This link may be shared automatically or manually depending on the referrer's preference. The computer may then automatically pay remuneration, in the form of a commissions, referral, and/or finder fees, to the first user in an appropriate currency. Additionally, the purchaser(s) becomes a second user(s) of the system. Should a new individual buy the same product from the second user(s), another embedded coded link may connect the first user to not only the second user but the new individual(s) as well. Both the first and second user of the system are remunerated for the new individual(s) purchase. This wave of creating and recreating users (1, 2, 3, etc.) based on purchases and linking them together may be indefinitely iterative. Remuneration on this specific product may be paid to all users linked together in the system, each time a purchase is made. The links may be unique and are fixed to each good or service being referred. Each respective user may pay for products or receive compensation according to a preferred currency or in a currency that is mandated by law.

FIG. 1 illustrates a system 100 for multi-level marketing of products via a set of computing devices. The system of FIG. 1 includes an administration computer or “administration network” computer 110, a user computing device 140 (user device), and a third party network computer 160. Each of the devices of FIG. 1, the administration network computer 110, the third party network computer 160, and user device 140 may communicate with each other via the communications network 190 such as the Internet or a cloud.

A memory at the administration network computer 110 may store commission program instructions 120 and jurisdiction program instructions 135 executed by a computer processor, and an administration database 130. User device 140 of FIG. 1 may be any user device such as a laptop, smartphone, tablet, computer, or smart speaker which may include a user device communication interface 150 which may be a network interface and a set of language program code instructions 155 executed by a computer processor. These language program code instructions may allow a processor to display different languages, fonts, or characters used by a specific language. The third party network computer 160 of FIG. 1 may include discount program instructions 180 and language program code instructions 185 executed by a computer processor, a memory, and a communication interface 170 which may be a network interface.

Use of the system may be as follows. A user submits a request via their user device 140 to register a product with the administration network computer 110 via a set of language program instructions 185 on a third party network computer 160. Execution of a set of jurisdiction program instructions 135 on the administration network computer 110 may determine whether the requested registration is valid under a set of jurisdiction rules set at the administration network computer 110. When the request for registration is valid, the product may be registered and registration data may be stored in the administration database 130. A user may connect user device 140 to the communication network 190 via the user device communication interface 150. Through the communication network 190, the user device 140 may communicate with the third party network computer 160 via the third party network communication interface 170. A set of third party network discount program instructions 180 allow the user to purchase the registered product from the third party network computer 160 and apply a discount to the product if a user has a code. Confirmation of the purchase and the code are then sent from the third party network computer 160 to the administration network computer 110. If the user did enter a code, a set of administration network commission program instructions 120 may be configured to pay commission to at least another user that is associated with the code. A new code may then generated by the administration network 110 per the administration network commission program instructions 120. The new code may associated with the user of the user device 140. The commission and the newly generated code are stored in the administration network administration database 130. The set of jurisdiction program instructions 135 may allow the administration network computer 110 to prepare tax documents required by specific jurisdictions such that income can be reported to a tax agency of a government.

Program code instructions of the administration network computer 110 may be organized as one or more software modules that include instructions for performing different functions. For example, a set of commission program instructions 120 may include base program instructions, advertising program instructions, calculation program instructions, and vendor program instructions. the administration network computer 110 may also access one or more databases, such as a compensation database that stores compensation data and a code database that stores program code or web link data, for example. The administration network computer 110 may accept sellers (third parties), where a “single product tree” multi-level marketing method is formed, comprising the steps of, providing at least one product, providing an MLM system with a seller's commission structure, and providing at least one seller of a product with its associated commission structure. The term “single product tree” refers to a unique structure for associating distributors of an MLM organization where products are used to identify relationships between distributors and commissions paid to related distributors. This “single product tree” structure allows for a particular user to be considered a sponsor or any other user based on that user sending promotions to other users to purchase a product that those other users were not previously associated with.

The administration network computer 110 may also provide a plurality of buyers/distributors, allow the at least one first seller to enroll a product to the MLM system, and allow at least a first buyer/distributor to purchase the product. Other functions that may be performed by the administration network computer 110 include allowing the at least the first buyer/distributor to advertise the product to other potential buyers/distributors and allowing at least a second buyer/distributor to buy the advertised product. Here the seller may set a commission structure for a product, may enroll the product into the MLM system, may allow the first, second and so on purchasers/distributors to purchase and advertise the product.

Once products have been enrolled with a commission structure, the administration network computer 110 may allow the purchasers/distributors to receive a commission based upon the seller's product commission structure. A distributor may refer to the non-salaried workforce selling the company's products or services. Here the earnings of the participants may be derived from a pyramid-shaped or binary compensation commission system. The term product may refer to articles or substances manufactured or refined for sale. Product may refer to an individual product, a line of products such as unique brand and model of drill, or a group of products such as all power tools. A service may refer to a system supplying a public need such as transport, communications, or utilities such as electricity or water.

A service which may be an act of dealing with a customer in a store, restaurant, or hotel by taking their orders, showing, or selling them goods. Additionally, a service which may be work that someone does or time that someone spends working for an organization, or a business that offers a particular type of help or work. The system 100 of FIG. 1 may distribute commissions according to an MLM tree or commission tree that is a payment structure in which commissions are given out at different percentages at different levels of the MLM tree, for example. In such a system distributor (users) that perform the sale or that are at a level that is “closer” to the distributor that performed the sale may receive larger commissions than distributors that are “farther” from the sale.

In another example, a first MLM distributor that performs a sale may receive a higher percentage than a second distributor that sponsored the first distributor, and a third distributor that signed up the second distributor may receive a lower commission than the commission received by the second distributor for the sale. Distributors in an MLM tree may be referred as “downline” or “upline” distributors depending on where different users rank on the MLM tree. For example, a first user that sponsors a second user is “upline” from the second user and the second user is “downline” from the first user in the MLM tree. Furthermore, any user/distributor that the second user sponsored would be considered downline from the second user and could be downline from the first user as well for a given MLM product tree. When a “single product tree” structure is used to identify commissions, users that are downline from the second user may not be downline from the first user based on the second user purchasing and advertising products not associated with the first user. When the first user purchases the product initially advertised by the second user, the second user may be considered upline of the first user after the first user for this product. Because of this, the second user is not relegated to always be downline from the first user just because the first user originally sponsored the second user to become an MLM distributor.

An MLM system which may be referred to as network marketing, may be a business model that depends on person-to-person sales by independent representatives, who may work from their home. A network marketing business may require the independent representatives to build a network of business partners or salespeople to assist with lead generation and closing sales. End of life of MLM tree may refer to the end of the MLM tree in which the commission tree may be restructured or eliminated. For example, further participants in the MLM may not receive a commission, the commission tree may “start up” (be reinitiated from a starting point) again, or the commission tree may be restructured in some other way. An existing MLM system may refer to currently existing or established companies that use the sales strategies to encourage existing distributors to recruit new distributors who are paid a percentage of their recruits' sales.

The administration network computer 110 may perform data security functions as well as functions associated with operation of an MLM algorithm that may calculate user compensation. Administration network computer 110 may be able to connect to a software application store, like the “Apple App Store,” where a program application can be downloaded from. Data security may refer to the process of protecting data from unauthorized access and data corruption throughout its lifecycle. Data security may include data encryption, tokenization, and key management practices that protect data across all applications and platforms. An MLM algorithm may refer to a calculation performed using a compensation decay rate to calculate the commissions for downline participants.

The commission program instructions 120 of FIG. 1 may cause a computer processor in the administration network computer 110 to continuously poll for user data (e.g., data of a user who may be a product purchaser or product distributor) from another processor executing a set of discount program instructions 180 at a third party network computer 160. Once the processor of the administration network computer 110 receives the user data, commissions may be calculated using the commission program instructions 120 of FIG. 1. These commissions may be calculated based on data stored in an administration network compensation database. Downline and upline commissions for the other users (product purchasers/distributors) within the MLM tree may be paid. The administration network compensation database may be included within the administration database 130 of FIG. 1 or it may be a separate database accessible by the administration network computer 110. Alternatively, instead of the administration network computer 110 polling a third party network computer 160, the third party network computer 10 may send the user data to the administration network computer 110 after a sale has been made.

An upline may refer to the MLM distributors that recruits work for as salespeople to sell the products or services. A downline may refer to the recruits the MLM distributors are able to secure as participants in the MLM system. Downline MLM trees may go across country boundaries and commissions may be paid out for an MLM tree even though the participants in the MLM tree may not reside in the same country. The commissions may be calculated for the appropriate exchange rate to ensure participants are paid in their residing countries currency in the correct amount.

A processor executing the commission program instructions 120 of FIG. 1 may continuously poll for user data from the third party network computer 160. The administration network computer 110 may then receive the user data from the third party network computer 160. Then the administration network computer 110 may determine whether the user entered a code. If the user did enter a code, the processor at the administration network computer 110 may extract the code and then access the administration network compensation database to identify one or more different spheres of influence or potential product purchasers/distributors levels. Such a code may have been received from user device 140 based on user inputs.

The processor at the administration network computer 110 may also associate a code for each of the different spheres of influence. The administration network computer 110 may then extract a corresponding commission for the code that was retrieved from in the administration network compensation database. The administration network computer 110 may then send the commission to the user (purchaser/distributor). The administration network computer 110 may track profits and payments as well as track taxes for users enrolled in the MLM system. The tracking of profits and payments may refer to the MLM system tracking the profits of the MLM and tracking the payments or commissions paid out to participants. The tracking of taxes may refer to tracking the commissions provided to participants for tax purposes. Then the administration network computer 110 may also compare the extracted code to data stored at an administration network code database a list of users and code sent to followers may be stored. This administration network code database may be the same database as the administration database 130 of FIG. 1 or it may be another database accessible by the administration network computer 110. The administration network computer 110 may extract a user ID and sphere of influence or potential purchaser/distributor by using the extracted code.

The administration network computer 110 may then compare the extracted sphere of influence or potential purchaser/distributor to data stored at the administration network compensation database. The administration network computer 110 may then use the extracted sphere of influence data to extract a corresponding commission from the administration network compensation database. The administration network computer 110 may then send the commission to an upline user. If the user did not enter a code, the administration network computer 110 may then initiate a set of administration network advertising program instructions.

The administration database 130 may store data received from various third parties (various sellers) that are part of a set of MLM trees. This data may contain a product ID, description of the product, an original cost of the product, a discount for the product, a cost of the product with the discount, a compensation plan decay rate, and a link to the product. An advertising link may refer to a link that directs a consumer to a product, service or good.

TABLE 1
Administration Database Data

| 3rd party | Home Depot | Home Depot | Furniture Store |
|---|---|---|---|
| ID | 654123 | 789654 | 123789 |
| Item | Drill | Table Saw | Couch |
| Original Cost | $59.00 | $119.00 | $999.00 |
| Discount | 15% | 10% | 10% |
| Discount Cost | $50.15 | $107.10 | $899.10 |
| Compensation | 50% | 50% | 30% |
| Decay Rate | | | |

Table 1 table displays data that may be stored at the administration database 130 of FIG. 1. When the administration network computer 110 receives product data from third party network computer 160 it creates a link for the product, stores the received data in the administration network administration database 130, and sends the created link back to the third party network computer 160. The administration network administration database 130 may be used to store data collected from various third parties that enrolled in the multi-level marketing system 100 of FIG. 1. The administration network administration database 130 may store the name of the third party, the ID for a product, a description of the product, the original cost of the product, the discount provided by the third party, the cost of the product with the discount, the compensation decay rate or how the downline commissions are calculated, and the link to the product.

The administration database 130 may store data that the administration network computer 110 may access when communicating events with the downlines and uplines, providing dynamic incentives or rewards for a product, distributing marketing materials, providing banking referrals, or distributing materials for suggestive selling, etc. Here, communicating events with downlines and uplines may refer to sending information relating to advertising events to participants of an MLM system. Dynamic incentives and rewards for a product may refer to incentives or rewards that are continuously updated for a product. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Banking referrals may refer to a structured flow of collecting and organizing referrals for banks. Businesses who have been unsuccessful in a credit application process with a bank may be asked for their permission to have their financial information passed to designated finance platforms who can contact the business in a regulated timeframe. Suggestive selling may refer to a sales technique where an employee asks a customer if they would like to include an additional purchase or recommends a product which might suit the client.

The jurisdiction program instructions 135 may allow a processor to receive data for a product that could potentially be added to products sold via an MLM organization. This product data may be stored at administration database 130 of FIG. 1. The data may include, for example, a product identifier (ID), a name, a cost, a discount, and/or a compensation decay rate, etc. to associate with the product. The execution of a set of jurisdiction program instructions 135 may cause the processor to check whether each parameter value of a set of parameter values included in the received data is allowed under a set of jurisdiction rules. These jurisdiction rules may be stored in a jurisdiction rules database that the processor may access.

As mentioned above user device 140 may include a memory, a processor, and a communication interface 150. The processor of user device 140 may execute instructions out of the memory when a user of user device 140 registers as a member of an MLM organization. Other tasks that a user may perform on user device 140 could include, identifying or connecting with other user devices (e.g., follower user devices), preparing advertisement information to share with follower user devices, receiving advertisement information prepared by other users, accessing product promotions at the third party network computer 160, and purchasing products based on offerings received from the third party network computer 160. Each of the tasks performed by user device 140 may include sending and receiving communications with the administration network computer 110, the third party network computer 160, or other user devices. Promotions prepared at a particular user device may be shared with other user device via administration network computer 110, third party network computer 160, a social media network computer, or directly from one user device to another. User devices may also be required to download and install an application program from an application store, such as the “Apple App store” as part of a process for registering as a member of an MLM organization.

The user device communication interface 150 of FIG. 1 may send and receive data via a communication network 190 which may be a wired and/or a wireless network. These language program code instructions 155 may allow a processor to display different languages, fonts, or characters used by a specific language and om certain instances may translate data sent to the administration computer 110 via communication interface 150.

As discussed above the third party network computer 160 of FIG. 1 may include a computer processor a memory, and communication interface 170. This third party network computer 160 may be controlled by various third parties, such as retail stores (stores that sell product consumables, services, jurisdictions, service networks, large box stores) or e-commerce sites that allow e-commerce sales. Such e-commerce sites may include an e-commerce shopping cart, that offer products to users at a discount, such as a product discount, in order to use the MLM system of FIG. 1. A jurisdiction may refer to a state, country, or territory that may each have respective taxes or reporting requirements. Product consumables may refer to goods by individuals and businesses that must be replaced regularly because they wear out or are used up. Service networks refer to a collection of people and information brought together on the internet to provide a specific service or achieve a common business objective, such as Angie's List. E-commerce sale may refer to sales of goods and services where the business takes place over the internet, an extra-net, Electronic Data Interchange (EDI), or other online system.

Payment may or may not be made online. Business in this context may be defined as an order placed by the buyer or price and terms of sale negotiated. E-commerce shopping cart may refer to a software used in E-commerce to assist visitors to make purchases online. Upon checkout, the software calculates the total of the order, including shipping and handling, taxes and other parameters the owner of the site has previously set. Retailer may refer to a person or business that sells goods to the public in relatively small quantities for use or consumption rather than for resale. Product discounts may refer to a reduce price or something being sold at a price lower than that product is normally sold for. It is a reduction to a basic price for a good or service. Large box stores may refer to a physically large retail establishment, usually part of a chain of stores, offers a variety of products to its customers. The term sometimes refers, by extension, to the company that operates the store, and which may be referenced as a supercenter, superstore, megastore, etc. These stores achieve economies of scale by focusing on large sales volumes. Because volume is high, the profit margin for each product can be lowered, which results in very competitively priced goods. The term “big-box” is derived from the store's physical appearance.

The third party network communication interface 170 of FIG. 1 may send data and receive via a communication network 190 which may be a wired and/or a wireless network.

The third party network discount program instructions 180 of FIG. 1 may be executed by a computer processor after being initiated by a set of third party network base program instructions. These instructions may cause the processor at the third party network computer 160 to prompt user for a discount code and to compare a received code to data stored at a third party network third party database. When a code received from a user matches data stored at the databases, a discount for the selected product may be applied and an order for a product may be processed.

The language program instructions 185 may allow a third party computer to register products and a set of associated parameters with the administration network computer 110 so long as the parameters are within the allowed values set by the jurisdiction rules. These product parameters may include, for example, the product ID, the name, the cost, the discount, or the compensation decay rate, etc. mentioned above. This may include localizing advertising materials by translating product information into respective languages and identifying prices for products in certain locations. These translations and currency conversions may be performed at either the administration network computer 110 or at the third party network computer 160. In certain instances jurisdiction information may be updated dynamically by checking spot currency conversion prices such that prices provided to certain locations may reflect current currency conversion rates.

The communications network 190 of FIG. 1 may be the Internet or a cloud. This communication network or any of the communication network interfaces 150 or 170 discussed herein may be a wired and/or a wireless network. Such a communication network, if wireless, which may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over Internet and relies on sharing of resources to achieve coherence and economies of scale, like a public utility, while third-party clouds enable organizations to focus on their core businesses instead of expending resources on computer infrastructure and maintenance.

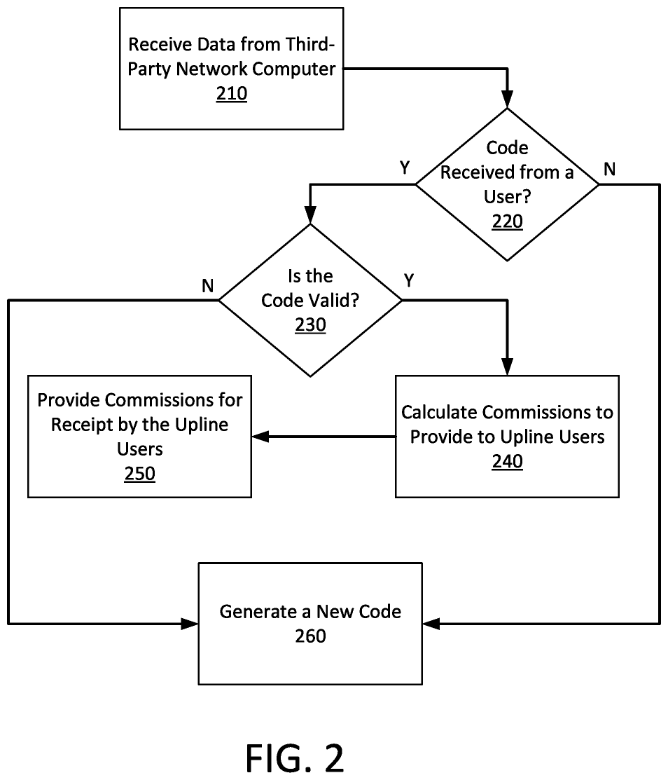

FIG. 2 illustrates a method that may be performed by a computer such as the administration computer of FIG. 1. FIG. 2 begins with step 210 where the administration network computer 110 receives data from the third party network computer 160 of FIG. 1. The received data may contain information on a purchased product and the discount code that can be applied to the purchase. This step may be facilitated by a set of administration network base program instructions stored in memory and executed by a processor. The administration network computer 110 may determine if the data received from the third party network computer 160 contains a code, at step 220. When the data does contain a code, the administration network computer 110 checks that both the product and the code match data stored at the administration network administration database 130 and/or other databases. The product and code may then be checked to see if they are valid at step 230 of FIG. 2. When the code and product are valid, the computer at administration network computer 110 may calculate commissions due to each upline user at step 240.

The commissions may be calculated by using the discount on the product and providing 50% of the discount to the user who supplied the code and then the remaining amount of the discount for the upline users at a 50% decay rate. For example, if the first user purchased a product that was originally $59.00 discounted by 15%, then a second user makes a purchase with the first user's code would receive $3.32 or 50% of the discount. Then any follower of the second user who uses the second user's code would cause the second user to receive 50% of the discount and the first user to receive 50% of the remaining discount or 50% of $3.32, and this may continue until there is only one cent left to pay out as a commission for the upline users. The threshold at which commission stops may be greater or less than one cent and may be set dynamically. This step may be facilitated by administration network calculation program instructions stored in memory and executed by a processor. Then, the administration network computer 110 may distribute the commission to the upline users at step 250 of FIG. 2. Commission may be paid directly to a user via the user device 140 of FIG. 1. The data may be stored in a database, for example, an administration network compensation database discussed above. Whether or not a valid code was entered, the administration network computer 110 may generate a new code for the user such that the user can give the code to followers and receive commission on their purchases at step 260 of FIG. 2. This generated code may be stored in the administration database 130 of FIG. 1 or another database, for example an administration network code database.

Actions performed by the administration network computer 110 may include associating user with specific jurisdictions and jurisdiction data may be used to identify tax reporting information, user language preferences (or settings), sales tax rate information, or other information associated with a jurisdiction (e.g. a city, state, country, or region).

A set of administration network base program instructions may instruct the administration network computer 110 to connect to the third party network computer 160, initiate a set of vendor program instructions and initiate a set of calculation program instructions.

A set of administration network calculation program instructions which may be initiated by operation of the administration network base program instructions may instruct the administration network computer 110 to extract the discount received from the third party network computer 160 as well as the compensation plan or commission plan (e.g. its decay rate or commission structure so that each downline gets less and less commission) in order to identify the commissions for the MLM (Multi-Level Marketing) tree. Once identified, this commission data may be stored data in a database at the administration network computer 110 of FIG. 1. A commission may refer to a payment to someone who sells goods that are directly related to the amount sold, or a system that uses such payments. A compensation plan or a commission plan may refer to the decay rate of the commissions provided to the MLM system from the discount offered by the third party, the third party also selects the decay rate to calculate the commissions offered to the first purchaser as well as the percentage offered to the downline participants. Payments may be made using a currency associated with a user, a user device, and a location where a product was ordered, purchased, or delivered.

Functioning of the calculation program instructions may be as follows. The process may begin with an administration network computer initiating the calculation. The administration network computer 110 may then extract a discount from the administration network administration database 130, which may be received from the third party network computer 160. Then the administration network computer 110 may extract the compensation plan decay rate from the administration network administration database 130. The administration network computer 110 may then determine the commissions available to the downline users, or the followers of the user that purchased the product.

The commissions may be calculated by using the discount on the product and providing 50% of the discount to the first participant and then the remaining amount of the discount for the downline users at a 50% decay rate. For example, if the first user purchased a product that was originally $59.00 discounted by 15%, the first user to make the purchase would receive $3.32 or 50% of the discount. Then any follower of the user who made the initial purchase would receive 50% of the remaining discount or 50% of $3.32, and this may continue until there is only one cent left to pay out as a commission for the downline users. Then the administration network computer 110 stores the data in the administration network compensation database. The administration network computer 110 sends a request to the user device purchase program instructions for the data stored in the user device user database. Then the administration network computer 110 may receive the user device user database data from the user device 140. The administration network computer 110 may store the received data, as well as the code data, in the administration network code database. The administration network computer 110 may then return to executing the administration network base program instructions.

A set of administration network advertising program instructions, which may be initiated by operation of the administration network commission program instructions 120, may determine the user's sphere of influence or contact list in order to provide the user's potential downline purchasers/distributors with a link and a code for the potential downline purchasers/distributors to become part of the MLM Tree Functioning of the advertising program instructions may be as follows. The process may begin with operation of the administration network commission program instructions 120 causing the administration network computer 110 to initiate the administration network advertising program instructions. The administration network computer 110 then determines if the user entered a code. If it is determined that the user entered a code the code is extracted. The administration network computer 110 compares the extracted code to the administration network compensation database.

The administration network computer 110 then may determine the user's sphere of influence level. If it is determined that the user did not enter a code, then the administration network computer 110 sets the user as the “First Participant”. Then the administration network computer 110 extracts the code for the next sphere of influence level or potential purchaser/distributor to provide the user's followers with a code that would allow them to join the multi-level marketing tree. The administration network computer 110 then may send the code and the link to the product to the user device 140. A set of administration network vendor (those selling products) program instructions, which may be initiated by operation of the administration network base program instructions, may result in data being received from the third party network computer 160. The administration network computer 110 may then store the data in the administration network administration database 130, create a link for the product, send the link back to the third party network 160, and return to executing the administration network base program instructions.

Functioning of a set of vendor program instructions may be as follows. The process may begin with operation of the administration network base program instructions causing the administration network computer 110 to initiate the administration network vendor program instructions. The administration network computer 110 may then receive data from the third party network computer 160. This data may include a product to be enrolled in the MLM system, an original cost of the product, a discount provided by the third party, a cost of the product with the discount, a compensation plan decay rate, etc. Then the administration network computer 110 may create a link for the product for the third party network computer 160. A vendor may be a seller of a product, such as a retailer. The administration network computer 110 may then store the received data and the created link in the administration network administration database 130. The administration network computer 110 may then send the link to the third party network computer 160. The administration network computer 110 may then return to executing the administration network base program instructions.

An administration network compensation database, which may be created through operation of the administration network calculation program instructions, may store various commissions for the different product purchasers/distributors. Table 2 illustrates data that may be stored at a compensation database consistent with the present disclosure. The administration network computer 110 may extract discount information and a compensation plan decay rate to calculate the downline commissions for additional users. This discount, decay rate information, and the sphere of influence levels may be stored in the administration network compensation database discussed above. The administration network compensation database may store information that cross-references a third party, a product ID, product description, the compensation plan decay rate, the various sphere of influence levels, a commission for each sphere of influence level, and a code to be used by the user's followers to enroll in the MLM system 100 of FIG. 1. The administration network compensation database may store a lottery structure for how the commissions are paid to users or freelancers. This lottery structure may refer to a process or thing whose success or outcome is governed by chance. A means of raising money by selling number tickets and giving prizes to the holders of number drawn at random. Freelancers may refer to a person who works as a writer, designer, performer, or the like, selling work or services by the hour, day, job, etc., rather than working on a regular salary basis for one employer. The data of table 3 may also identify a user identifier (ID) of a purchaser of a product.

TABLE 2
Compensation Database Data

| Third party | Home Depot | Home Depot | Home Depot |
|---|---|---|---|
| ID | 654123 | 654123 | 654123 |
| Item | Drill | Drill | Drill |
| Compensation | 50% | 50% | 50% |
| Decay Rate | | | |
| Sphere of | First | 2 | 3 |
| Influence Level | Participant | | |
| Commission | $3.31 | $1.66 | $0.83 |
| Code | N/A | 654123- | 654123- |
| | | SOI2 | SOI3 |

Table 3 illustrates data that may be store at an administration network code database. This data may identify the codes given to the product purchasers/distributors (users) for the product purchasers/distributors (user) to pass to their potential purchasers/distributors to advertise or promote a product that a user has purchased. The administration network code may also cross-reference a user ID with a product ID, and product name, a sphere of influence (/potential purchaser/distributor), and a code that may be shared with followers.

TABLE 3
Code Database Data

| | | | Sphere of Influence/ | |
|---|---|---|---|---|
| | | | potential purchaser/ | Code for |
| User ID | ID | Item | distributor | Followers |
| JS1234 | 654123 | Drill | First Participant | 654123-SOI2 |
| HY8569 | 654123 | Drill | Second Participant | 654123-SOI3 |
| TB4567 | 789654 | Table | First Participant | 897456-SOI2 |
| | | Saw | | |
| EL51346 | 789654 | Table | Second Participant | 897456-SOI3 |
| | | Saw | | |

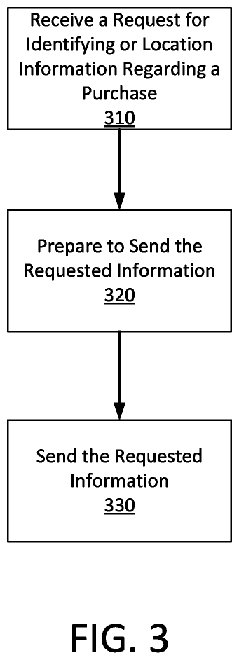

FIG. 3 illustrates a series of steps that may be performed at a user device when product information is provided to a multi-level-management system. After a user initiates a product purchase, their user device may receive a request for information from which the user's location may be identified. This may include requesting data that may be used to look up the user in a database or may include requesting that data be sent from the user device that identifies a location where the user device is located. Alternatively, or additionally the requested information may be related to a location where a purchased product will be delivered.

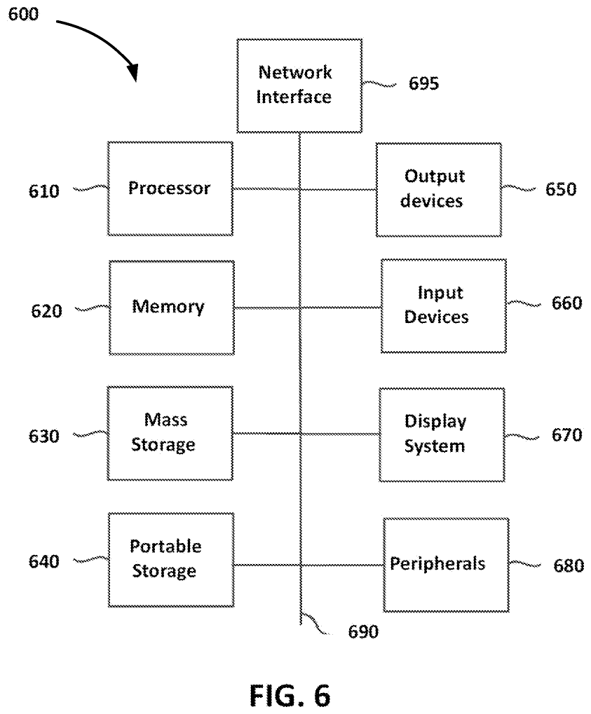

Next in step 320, the requested information may be prepared to be sent to a computer such as the administration computer 110 or the third party network computer 160 of FIG. 6. This information may be used to identify requirements that must be met based on a jurisdiction associated with the product purchase. An amount of sales tax that should be charged and governmental organizations to which a tax should be paid or to which an income statement should be sent. After step 320, the requested information may be sent to the administration computer 110 or third party network computer 160 such that a user device may be provided product data and purchase related information in a language associated with a user or a location.

This purchase process may include allowing a user device to request to purchase a product from the third party network computer 160, and directing the user device to a website or an online store that has data in an appropriate language. This may be facilitated with a QR code which can be scanned by a QR scanner. Then, a set of jurisdictional program instructions may direct the user device to the website or an online store via a web browser or similar application on the user device 140. A link stored in the administration network administration database 130 may be used to automatically generate a request to purchase of a specific product. Then the user device 140 may then allow the user to enter a discount code. The code may be entered automatically if the user selected a link received from the administration network computer 110. The code may also be entered automatically by execution of program instructions when such instructions are embedded in a QR code. The user may enter the discount code in a graphical user interface (GUI) element such as a text box or input box, either via a native application on the user device 140 or directly via the third party network computer 160 (for example, via a web browser).

The user device 140 may then allow the user to finalize an order. This step may involve the transfer of payment information from the user device 140 to the third party network computer 160. Any or all these steps may be facilitated by user device communication interface 150, user device purchase program instructions stored in memory and executed by a processor, or a user device user database stored in memory.

A set of instructions referred to as user device purchase program instructions may allow a user device to connect to the third party network computer 160, allow a purchaser/distributor to select a product and an associated link. This process may include, determining whether the purchaser/distributor entered a code, and sending the link and code, if available, to the third party network computer 160.

A set of instructions referred to as purchase program instructions may cause the user device 140 to continuously poll for a request from the administration network computer 110 for user device user database data. The user device 140 may then receive a request from the administration network computer 110 for the user device user database data. Then the user device 140 may send the user device user database data to the administration network computer 110. The user device 140 may then connect to the third party network computer 160. Then the user may select a product from the third party network computer 160. The user may select a link from the third party network computer 160. Then the user device 140 if the user entered a code. If it is determined the user entered a code, the user device 140 may send the code to the third party network computer 160. The user data may be data to purchase the product such as name, address, billing information, etc. The user data sent to the third party network computer 160 may include information from a credit card system. A credit card system may refer to a system that allows cardholders to borrow funds with which to pay for goods and services with the condition that the cardholders pay back the borrowed funds, plus interest, as well as any additional agreed-upon charges.

A user device user database may contain the user's (product purchasers/distributors) followers (sphere of influence) as well as the followers contact information for them to receive commissions on their purchases. A distributor contact list or followers may refer to the recruits or followers on social media that a distributor has secured to participate in their downline. The user device user database may include ratings and recommendations from the users. Rating and recommendation modules may refer to modules in which a company, entity, or person provides ratings and/or recommendations for products, goods, or services.

Table 4 displays data that may be stored at a user device user database. The data of table 4 cross-references user information with user follower information. The user device user database stores the user's ID, the followers user ID, codes provided to the followers, the follower's e-mail address, the follower's phone number, and the follower's address. The user device user database may store the follower's social media information such as user social media account information (Twitter, Instagram, Facebook, etc.). The user database may contain social media plug-ins for enhanced marketing or social media aggregators. Social media plug ins for enhanced marketing may refer to sharing content with other people through social media platforms, for example a share or like button. The user device user database may contain payment information such as bank accounts, credit card information, PayPal, Venmo, etc. A user ID or ID Enrollment may refer to a participant enrolling in an MLM product tree through an ID, which may be unique to each participant in the MLM system. Social media aggregators may refer to a tool that allows a person to collate posts and updates from many different social media feeds. It creates an organized view of social posts on a specific topic and are often used to display user-generated content on live social walls.

TABLE 4
User Database Data

| | | | |
|---|---|---|---|
| User ID | JS1234 | JS1234 | JS1234 |
| Follower ID | HY8569 | IT8527 | RW4569 |
| Code for Followers | 654123-SOI2 | 654123-SOI2 | 654123-SOI2 |
| Follower E-mail | HY8569@gmail.com | IT8527@yahoo.com | RW4569@gmail.com |
| Follower Phone | 781-654-8972 | 231-456-7891 | 654-987-3217 |
| Follower | 123 Main Street, | 58 Elm Street, | 96 2nd Ave, Salt |
| Address | Boston, MA | Burlington, VT | Lake City, UT |

Operation of user device downline program instructions may cause the user device 140 to continuously poll to receive the code and link from the administration network computer 110 to allow the purchaser/distributor to pass the code and link to the user's followers stored in the user device user database. Functioning of the downline program instructions may be as follows. The process begins with the user device 140 continuously polling for the code and the link from the administration network computer 110. The user device 140 receives the code and the link from the administration network computer 110. The user device 140 provides a selection of the first follower in the user device user database. The user device 140 extracts the followers contact information stored in the user device user database. Then the user device 140 sends the code and link to the follower's contact information. The code and link may be shared on social media sites, such as Twitter, Instagram, Facebook, etc. This may allow the user's followers to receive the code and link based on communications that use one or more of these social media accounts. The user device 140 may then determine if there are more followers remaining in the user device user database. If it is determined that there are more followers stored in the user device user database, the user device 140 selects the next user stored in the user device user database. When the user device 140 determines that there are no more followers remaining in the user device user database, then the process may end.

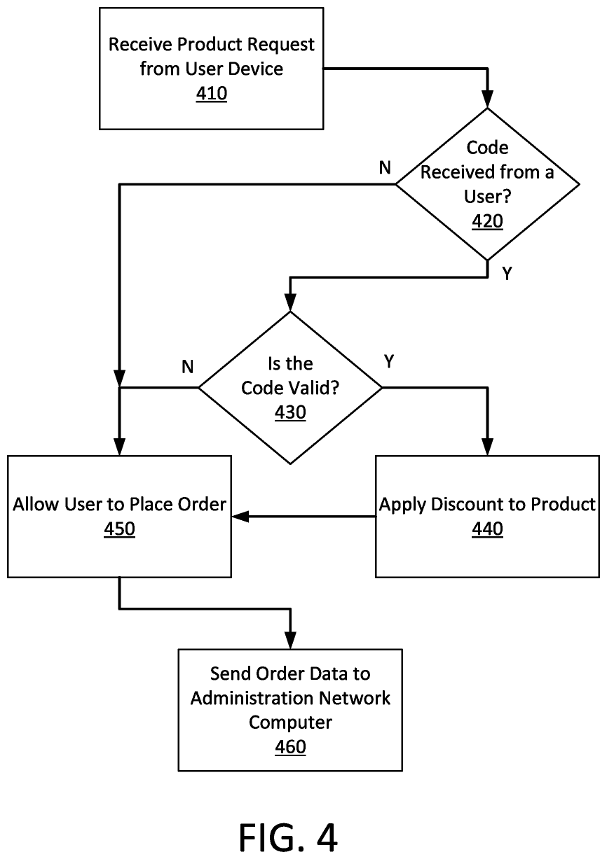

FIG. 4 illustrates a method that may be performed by a computer such as the third party network computer of FIG. 1. FIG. 4 begins with step 410 where the third party network computer 160 receives a request from a user device 140 to purchase a product. This request may be facilitated by a public facing webpage, for example, an online store page for the third party retailer that controls the third party network computer 160. The third party network computer 160 then may identify if the user entered a code, at step 420. Here, the code may be entered prior to a request for purchase. For example, before checking out using an online shopping cart the user may be able to enter discount codes. If a code was entered, the third party network computer 160 may identify whether the code is recognized as a valid code for receiving a discount, at step 430 of FIG. 4.

The code may be retrieved from the administration network computer 110 via the third party network communication interface 170. Codes may be stored locally on the third party network computer 160 or in a third party network third party database accessible by the third party network computer. If the code is valid, the third party network computer 160 applies a discount to the product, at step 440. An amount associated with this discount may be retrieved by the administration network computer 110 via the third party network communication network interface 170. Discount amounts may be stored locally at a third party network database. The third party network computer 160 may then allow the user to finish placing the order for the product, at step 450 of FIG. 4. The third party network computer 160 may then send some or all the data on the purchase, including the discount code if one was provided, to the administration network computer 110, at step 460. Any or all these steps may also be facilitated by execution of different sets of program instructions that may include: third party network base program instructions and third party network administration program instructions.

A third party network computer 160 may execute administration program instructions to cause the third party network computer to connect to the administration network computer 110, send the data for the products to be purchased, receive a link from the administration network computer 110, store the link in a third party network database, and return to executing a set of base program instructions. The process may begin with the third party network computer 160 administration program instructions being initiated by the third party network base program instructions. The third party network 160 may connect to the administration network computer 110 and then the third party network computer 160 may send third party network database data to the administration network computer 110. Then the third party network computer 160 may store the link in the third party network third party database.

Operation of a third party network discount program instructions 180 may include extracting a link sent by the user device 140 and comparing it to data stored at the third party network third party database. This may result in the identification of a corresponding discount for a selected product. This process may include identifying whether a user entered a code or not, after which a discount is applied, and the order is processed.

The process of applying a discount may begin by extracting the link received from the user. Then the third party network computer 160 may compare data included in the extracted link to data stored at the third party network database. The third party network computer 160 may then extract a corresponding discount from the third party network third party database. Then the third party network computer 160 may apply the extracted discount to the user's order. The third party network computer 160 may then determine if the user entered a code. When it is determined that the user did not enter a code, the third party network computer 160 may send the user data to the administration network computer 110 without a code. When it is determined that the user entered a code, the third party network computer 160 may send the code and the user data to the administration network computer 110. Next, the third party network computer 160 may process the user's order.

A third party network third party database may store information about the products that may be purchased. This the third party network database may include local media for the product or service, where this local media may refer to the various types of media, such as photos, videos, text, sounds, haptics, online product descriptions, etc. for enhanced marketing.

Table 5 illustrates data that may be stored at a third party database. This data may include information about the products enrolled in the MLM system as well as a link created by execution of the administration network vendor program instructions. The third party network database may cross-reference a product ID, and product description, an original cost of the product, a discount provided by the third party for the product, a cost of the product with the discount, a compensation plan decay rate which the third party enters, and a link received from the administration network computer. The third party network third party database may include the rates of exchange for product returns, marketing materials, airline sky miles, etc. Product returns may refer to a process in which a customer or consumer takes previously purchased product, merchandise, or goods back to the retailer, and in turn receive a refund in the original form of payment, exchange for another product (identical or different), or a store credit.

The information about the product or service which may be advertisements to the network, or as seen on TV sales. Advertisements to the network may refer to the advertisement provided to the MLM system from the third party offering a product, good or service. These as seen on TV sales may refer to a generic nameplate for products advertised on television in the United States for direct response mail-order through a toll-free telephone number. Marketing materials may refer to a means of marketing, advertising or promotional materials developed by or for license (or subject to licensee's approval) that promote the sale of the licensed product, including but not limited to, television, radio and online advertising, point of sale materials (e.g., posters, counter-cards), packaging advertising, print media and all audio or video media. Airline sky miles may refer to a loyalty program offered by airlines and/or credit cards. Typically, consumers accumulate a set amount of miles based on how much is spent on a ticket or a credit card and are also known as frequent flyer miles or travel points. Users of the MLM system may also be provided with credits that may be in the form of cash back promotions redeemable via a particular type of currency associated with the user.

TABLE 5
Third Party Database Data

| | |
|---|---|
| ID | 654123 |
| Item | Drill |
| Original Cost | $59.00 |
| Discount | 15% |
| Discount Cost | $50.15 |
| Compensation Decay Rate | 50% |
| Link | HDDrill654123 |

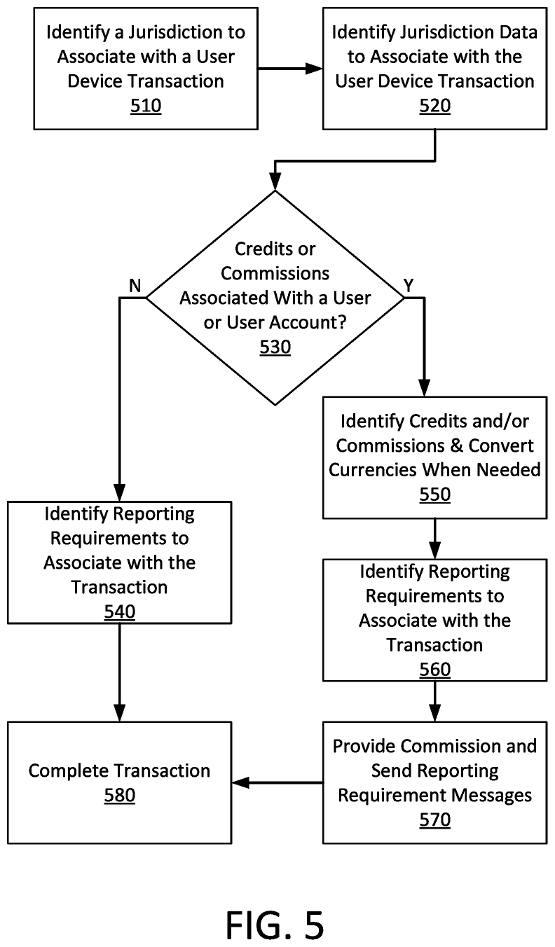

FIG. 5 illustrates steps that may be performed between an administration network computer and the third party network computer of FIG. 1. FIG. 5 begins with step 510 wherein the franchise owner program instructions 185 cause the third party network computer 160 to send a request to the administration network computer 110. The franchise program instructions 135 may cause the administration network computer 110 to poll for a request from the third party network computer 160 to register a product. These requests may be submitted manually or may be generated from a franchise database on the third party network computer 160. The request may include parameters for the product such as compensation decay rate, discount rate, and an ID. When the third party is a franchise, the request may include a franchise ID which may identify both the individual franchise and the franchising company. The administration network computer 110 may determine if the third party is a franchise, at step 520. This may be determined by checking the received data for a franchise ID. If there is no franchise ID, the process may then move to step 550 where the product is registered. When determination step 520 identifies that the third party is a franchise, program flow may move to determination step 530.

The administration network computer 110 may then determine is step 530 whether the received product parameters fall within the allowed values set by the franchise rules. For example, the franchise rules may set a maximum discount rate for a product. If the discount rate parameter for the product submitted by the third party network computer 160 is above the maximum allowed value, the request for registration may be rejected. These franchise rules may be stored in a franchise rules database on the administration network computer 110. When the parameters for the product are not within the allowed values, the administration network computer 110 rejects the registration at step 540. The franchise program instructions 135 may terminate or may cause the administration network computer 110 to return to polling for another request for product registration. If the product parameters are within the values allowed by the franchise rules, the product is registered, at step 550. Registration may include storing the product parameters in the administration network database 130.

Functioning of the franchise program instructions 135 may be as follows. The process begins with the administration network computer 110 polling for product data from the third party network computer 160. Product data includes at least the product ID, franchise ID, original cost, discount, and decay rate. The administration network computer 110 compares the product ID from the product data send by the third party network computer 160 to the product ID in a franchise rules database. The administration network computer 110 determines if there is an identical ID in the product data and the franchise rules database. If there is a matching product ID, the administration network computer 110 extracts the rest of the data stored in that entry of the franchise rules database.

The administration network computer 110 determines if the franchise ID from the product data matches one of the extracted valid franchise IDs. When the franchise ID is valid, the administration network computer 110 determines if the original cost component of the product data is above or equal to the minimum original cost from the franchise rules database for that product. When the original cost is not above the minimum original cost from the franchise rules database for that product, the cost may be set to the minimum original cost instead of denying the entire product. When the original cost is above the minimum original cost, the administration network computer 110 determines whether the original cost component of the product data is below or equal to the maximum original cost from the franchise rules database for that product. If the original cost is not below the maximum original cost from the franchise rules database for that product, the cost may be set to the maximum original cost instead of denying the entire product.

The administration network computer 110 determines if the discount component of the product data is above or equal to the minimum discount from the franchise rules database for that product. If the discount is not above the minimum discount from the franchise rules database for that product it may be set to the minimum discount instead of denying the entire product. When the discount is above the minimum discount, the administration network computer 110 may determine whether the discount component of the product data is below or equal to the maximum discount from the franchise rules database for that product. When the discount is not below the maximum discount from the franchise rules database for that product, the discount applied may be set to the maximum discount instead of denying the entire product.

The administration network computer 110 may determine whether the decay rate component of the product data is above or equal to the minimum decay rate from the franchise rules database for that product. When the decay rate is not above the minimum decay rate from the franchise rules database for that product, the decay rate may be set to the minimum decay rate instead of denying the entire product. When the decay rate is above the minimum decay rate, the administration network computer 110 determines whether the decay rate component of the product data is below or equal to the maximum decay rate from the franchise rules database for that product. When the decay rate is not below the maximum decay rate from the franchise rules database for that product, the applied decay rate may be set to the maximum decay rate instead of denying the entire product.

If none of the parameters fall outside the allowed values, the administration network computer 110 may store the product data in the administration database 130. The administration network computer 110 may send an update to the third party network computer 160 that the product has been registered. This update may be, for example, a Boolean TRUE, or the string “allowed”. If one or more of the parameters for the product fall outside the allowed values, the administration network computer 110 sends an update to the third party network computer 160 that the product has been denied. This update may be, for example, a Boolean TRUE, or the string “denied”, and may also contain the reasons the product was denied.

Table 6 illustrates data that may be stored at a jurisdiction database that may be accessed by a computer when jurisdiction data associated with a user or a user device is identified. Data stored at a jurisdiction database may identify a country, state, or city, a global positioning system (GPS) coordinate, a range of GPS coordinates, or an address that corresponds to a respective jurisdiction. This data may also identify a jurisdiction's language, a language spoken by a user, a currency, and an exchange rate. This data may also include a minimum and a maximum allowable commission for products sold via a multilevel marketing (MLM) organization in a jurisdiction. GPS coordinates or location information for respective jurisdictions may be stored as data files since boundary lines between jurisdictions can sometimes be arbitrary. In certain instances, coordinate ranges are not as simple as, for example, between longitude 112.54 and 114.67, in such an instance, the jurisdiction database may store an address on the cloud which corresponds to an international database that accurately reflects jurisdiction boarders. Information stored at a jurisdiction database may be continuously updated.

TABLE 6
Jurisdiction Database Data

| | | | |
|---|---|---|---|
| Jurisdiction | New Mexico | Ghana | Balder's |
| | | | Gate |
| GPS | NMCoords.dat | GhanaGPSmap.dat | BG_map.dat |
| Languages | English, | English, Akan | Common |
| | Spanish | | |
| Currency | $ | GH€ | gp |
| Symbol | | | |
| Exchange Rate | 1 | 0.17 | 311 |
| (From USD) | | | |
| Minimum | N/A | N/A | 20% |
| Compensation | | | |
| Decay Rate | | | |
| Maximum | N/A | N/A | 80% |
| Compensation | | | |
| Decay Rate | | | |

The jurisdiction data of table 6 identifies that the jurisdiction of the state of New Mexico is associated with GPS coordinate data file MNCoords.dat, a currency of dollars ($), and an exchange rate of 1. This data also indicates that this jurisdiction has not been assigned a minimum or maximum compensation decay rate. In such an instance, compensation rates may be set according to a compensation schedule. Table 6 also indicates that the jurisdiction of New Mexico is associated with languages of English and Spanish. The data of table 6 also identifies similar information for the country of Ghana and an online location of Balder's Gate. Note that each location is associated with GPS data, languages, an exchange rate, and possibly with a minimum and maximum compensation decay rates.

Note that Table 6 identifies a minimum compensation decay rate of 20% and a maximum compensation decay rate of 80%. In such a jurisdiction, when a user/distributor offers a product for sale, that user may attempt to set a maximum or a minimum compensation decay rate and this rate may be accepted with it is within a range between the minimum of 20% and the maximum of 80%.

Table 7 illustrates data that may be stored at a credit database.

TABLE 7
Credit Database Data

| | Base | Currency | Exchanged |
|---|---|---|---|
| User ID | Credits | Symbol | Credit Value |
| GF5738 | 400 | $ | 400 |
| BN4701 | 650 | € | 591.88 |

The credit database data cross-references user IDs with and their associated credits, the credits are stored as a fixed amount comparable to USD ($) and also stored as the converted amount based on the currency used in the user's current jurisdiction, in an embodiment the database may need to be updated constantly because of fluctuating currency exchange rates. The credits stored in this credit database may have been provided to particular users as a bonus, may be credits earned as commissions and not yet paid to a user, or may be a combination of both. Table 7 indicates that user GF5738 has a base credit value of $400 when the US dollar is a base currency of the MLM organization. Note that the currency symbol associated with user GF5738 is the US dollar sign ($). Since the value of the credits for user GF5738 is already in US dollars, the exchanged credit value associated with user GF5738 is 400 dollars. Table 7 also identifies that user BN4701 has a value of credits of 650 US dollars ($) and that user BN4701 receives payment in Euros (€). The exchanged credit value of Euros that currently corresponds to 650 dollars is 591.88 Euros.

In certain instances, a database accessible by a third party computer may associate user IDs with a language that user speaks. For example, such user language data may identify that user GF5738 speaks English and that user BN4701 speaks Portuguese.

FIG. 5 illustrates steps that may be performed by a processor executing instructions relating to jurisdictions associated with user or with their user devices. In step 510 of FIG. 5 the processor may identify a jurisdiction to associate with a user device. In certain instances, this may include receiving location information from the user device, for example, by receiving global positioning coordinates or location identified by operation of program code at a user device. Alternatively, the jurisdiction identified in step 510 may correspond to information provided by or associated with a user, the jurisdiction may be identified based on locations where a product is delivered or where commissions are provided for receipt by distributor users that receive commissions from the sale of the product.

When the jurisdiction of the user or user device is tied to the location of the user device, coordinates received in step 510 may be compared with information that identifies what jurisdiction corresponds to the location of the user device. For example, data from a jurisdiction database may cross reference location information with jurisdiction data. This jurisdiction data may identify income tax reporting requirements, state sales tax information, or local sales tax information such that applicable taxes can be paid or income reported to a government. When the set of coordinates received in step 510 do not match the coordinates stored in the jurisdiction database, a default jurisdiction may be used. For example, the mountains of Utah, a closest jurisdiction may be used instead (e.g. Provo Utah). Alternatively, an error message may be identified and provided to the user.

When there is a set of coordinates received in step 510 match jurisdiction coordinates, data associated with that jurisdiction data may be accessed to identify tax information, language or languages that the user speaks, a currency symbol associated with the jurisdiction, an exchange rate, a minimum compensation decay rate, and/or a maximum compensation decay rate in step 520 of FIG. 5. Step 520 may also associate this jurisdiction data with the user device, with a transaction, or both. In an instance when a user orders a product to be delivered in New York City, sales tax associated with that order may be added to the purchase price according to the laws of New York City and State. Program flow may then move to step determination step 530 where credits or commissions associated with a transaction may be identified. When there are no credits or commissions associated with the transaction, program flow may move to step 540 where reporting requirements associated with the transaction may be identified. This may include identifying sales tax to apply to the transaction. Step 540 may also include associating the user device with an account of a new user. Here the user of the user device may be classified as a distributor of the product that was purchased in the transaction and this new user may then be set up to receive commissions based on sales that are associated with them (e.g. via an assigned code) and with purchase of the product. After step 540, the transaction may be completed in step 580, this may include receiving payment for the product and any applicable taxes.

When determination step 530 identifies that there are credits or commissions associated with the user or with a user account, program flow may move to step 550 where credits and/or commissions are identified. Step 550 may include identifying a currency to associate with the transaction and/or commissions and converting currencies and/or commission amounts to specific payments. Credits identified in step 550 may be bonus points assigned to the user that may be converted into funds that may be used to complete the transaction. The commissions identified in step 550 may be identified by parsing codes assigned to different users of a product tree that track sales of a product from one user to another. Here again these commissions may be paid out according to a commission schedule or to a commission decay rate. In certain instances, commissions paid and sales tax charged may be associated with different jurisdictions. For example, a sales tax may correspond to a location of San Francisco Calif. when a purchased product is delivered to an address in San Francisco and commissions related to that purchase could be paid in Japanese Yen when an upline distributor of the product associated with the product purchase resided in Japan. The credits discussed above may be stored as a fixed amount comparable to USD ($) and may also stored as the converted amount based on the currency associated with a user jurisdiction. A database that stores credit data may updated constantly to keep track of fluctuating currency exchange rates.

Next in step 560, reporting requirements may be associated with the transaction, this may include identifying taxes that are due or may include identifying that commission income should be reported to the jurisdiction(s) identified in step 520 of FIG. 5. These commissions may be provided to user/distributors in step 570. Step 570 may also include sending messages to and possibly taxes due to specific entities according to jurisdictional reporting requirements, preferences, or settings. Data sent in step 570 may include sending one or more of a currency symbol, an exchange rate, a user identifier (ID). The commissions paid in step 570 may be according to a compensation decay rate, where each user/distributor associated with a product purchase may receive commissions based on a number of distributor levels that separate them from that purchase. After step 570, the transaction may be completed in step 580.

When the purchase of this product results in commissions being paid to a user/distributor that resides in Japan, an income statement may be provided to the Japanese government according to the tax reporting laws of Japan. These taxes may be identified or income statements may be prepared and sent to government entities in the jurisdictions affected by the purchase of the product. Steps 540 or 560 may also identify any other reporting requirement that may be associated with a transaction. This may include preparing a receipt to send a purchaser of the product, preparing a message to send to a recipient of the product, or preparing messages to send to user/distributors regarding the transaction.

A processor executing instructions may access data that identifies a language associated with a user such that transaction information may be provided to that user in their native or preferred language. User identifying information may be sent to a third party network from a computer of an administration network or from a user device. This may include sending a first listed language of that jurisdiction and a user ID to the third party network computer 160. Alternatively, all listed languages may be sent to the third party network computer. In another instance, a user may be prompted to select a language from the listed languages. In such an instance, the user may be prompted to confirm their preferred language before information identifying that language is sent to the third party network computer. In instances when the user has already selected a language, that language may override all languages selected. In certain instances selected languages may be identified based on location data.

FIG. 6 illustrates a computing system that may be used to implement an embodiment of the present invention. The computing system 600 of FIG. 6 includes one or more processors 610 and main memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 650, peripheral devices 680, and network interface 695.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 650 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a FLASH memory, compact disk or Digital video disc, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, or a pointing device, such as a mouse, a trackball, stylus, or cursor direction keys. Additionally, the system 600 as shown in FIG. 6 includes output devices 650. Examples of suitable output devices include speakers, printers, network interfaces, and monitors.

Display system 650 may include a liquid crystal display (LCD), a plasma display, an organic light-emitting diode (OLED) display, an electronic ink display, a projector-based display, a holographic display, or another suitable display device. Display system 650 receives textual and graphical information and processes the information for output to the display device. The display system 650 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 680 may include any type of computer support device to add additional functionality to the computer system. For example, peripheral device(s) 680 may include a modem or a router.

Network interface 695 may include any form of computer interface of a computer, whether that be a wired network or a wireless interface. As such, network interface 695 may be an Ethernet network interface, a BlueTooth™ wireless interface, an 802.11 interface, or a cellular phone interface.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer can also include different bus configurations, networked platforms, multi-processor platforms, etc. The computer system 600 may in some cases be a virtual computer system executed by another computer system. Various operating systems can be used including Unix, Linux, Windows, Macintosh OS, Palm OS, Android, iOS, and other suitable operating systems.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory/disk, a hard disk, magnetic tape, any other magnetic medium, a CD-ROM disk, digital video disk (DVD), any other optical medium, RAM, PROM, EPROM, a FLASH EPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The functions performed in the processes and methods which may be implemented in differing order. Furthermore, the outlined steps and operations are only provided as examples, and some of the steps and operations which may be optional, combined into fewer steps and operations, or expanded into additional steps and operations without detracting from the essence of the disclosed embodiments

What is claimed is:

1. A method for hyperlinking products in international multi-level systems, the method comprising:
storing information regarding a hyperlink associated with a plurality of locations, each location associated with a language of a product offer;
identifying a location associated with a user of a user device based on data received regarding activation of a hyperlink by the user device, wherein the location is identified from among the plurality of locations associated with the hyperlink;
identifying that a product offer associated with a distributor can be provided to the user device via a language associated with the identified location and the data received from the user device;
initiating the sending of the product offer to the user device in the language associated with the identified location and with the data received from the user device, the product offer including a code associated with the distributor; and
allocating a commission to the distributor based on the user of the user device purchasing the product via the hyperlink associated with the product offer and in accordance with the code.

2. The method of claim 1, further comprising:
receiving marketing data associated with the product offer from a computing device of the distributor; and
associating the marketing data with the product offer and the code based on the distributor purchasing the product.

3. The method of claim 1, further comprising storing data that identifies the user as a second distributor that is downline of the distributor in accordance with the code.

4. The method of claim 3, further comprising:
associating a second code with the second distributor and with a second product after the second product is purchased by the second distributor;
sending marketing data associated with the second product and with the second distributor to the computing device of the distributor, wherein the second product is purchased by the distributor according to the marketing data associated with the second product; and
storing data that identifies the distributor as being downline of the second distributor in accordance with the second code.

5. the method of claim 4, further comprising:
receiving information associated with a sale of the second product;
identifying that the sale of the second product is associated with the distributor and the second distributor based on the code and the second code linking the second product, the distributor, and the second distributor as members of a chain of distributors; and
allocating commissions associated with the sale of the second product to the distributor and the second distributor in accordance with the code and the second code.

6. The method of claim 1, wherein commissions paid to distributors downline of an upline distributor are less than commissions paid to the upline distributor.

7. The method of claim 1, further comprising identifying that the location associated with the user is different from a second location associated with the distributor.

8. The method of claim 7, further comprising:
performing a first action based on the location associated with the user; and
performing a second action based on the second location associated with the distributor.

9. The method of claim 8, wherein the first action corresponds to applying a sales tax associated with the sale of the first product based on the location.

10. The method of claim 8, wherein the second action corresponds to sending income reporting data based on the distributor being associated with the second location.

11. A non-transitory computer-readable storage medium having embodied thereon a program executable by a processor for or hyperlinking products in international multi-level systems, the method comprising:
storing information regarding a hyperlink associated with a plurality of locations, each location associated with a language of a product offer;
identifying a location associated with a user of a user device based on data received regarding activation of a hyperlink by the user device, wherein the location is identified from among the plurality of locations associated with the hyperlink;
identifying that a product offer associated with a distributor can be provided to the user device via a language associated with the identified location and the data received from the user device;
initiating the sending of the product offer to the user device in the language associated with the identified location and with the data received from the user device, the product offering including a code associated with the distributor; and
allocating a commission to the distributor based on the user of the user device purchasing the product via the hyperlink associated with the product offer and in accordance with the code.

13. The non-transitory computer-readable storage medium of claim 12, further comprising instructions executable to store data that identifies the user as being a second distributor that is downline of the distributor in accordance with the code.

14. The non-transitory computer-readable storage medium of claim 13, further comprising instructions executable to:
associate a second code with the second distributor and with a second product after the second product is purchased by the second distributor;
send marketing data associated with the second product and with the second distributor to the computing device of the distributor, wherein the second product is purchased by the distributor according to the marketing data associated with the second product; and
store data that identifies the distributor as being downline of the second distributor in accordance with the second code.

15. The non-transitory computer-readable storage medium of claim 14, further comprising instructions executable to:
receive information associated with a sale of the second product;
identify that the sale of the second product is associated with the distributor and the second distributor based on the code and the second code linking the second product, the distributor, and the second distributor as members of a chain of distributors; and
allocate commissions associated with the sale of the second product to the distributor and the second distributor in accordance with the code and the second code.

16. The non-transitory computer-readable storage medium of claim 11, wherein commissions paid to distributors downline of an upline distributor are less than commissions paid to the upline distributor.

17. The non-transitory computer-readable storage medium of claim 11, further comprising instructions executable to identify that the location associated with the user is different from a second location associated with the distributor.

18. The non-transitory computer-readable storage medium of claim 17, further comprising instructions executable to:
perform a first action based on the location associated with the user; and
perform a second action based on the second location associated with the distributor.

19. The non-transitory computer-readable storage medium of claim 18, wherein the first action corresponds to applying a sales tax associated with the sale of the first product based on the location.

20. The non-transitory computer-readable storage medium of claim 18, wherein the second action corresponds to sending income reporting data based on the distributor being associated with the second location.
